(19) United States
(12) Patent Application Publication
(10) Pub. No.: US 2017/0138536 A1
(43) Pub. Date: May 18, 2017

(54) SEALED, HEAT-INSULATED VESSEL HOUSED IN A BUOYANT STRUCTURE

(71) Applicant: GAZTRANSPORT ET TECHNIGAZ, Saint Rémy Les Chevreuse (FR)

(72) Inventors: Mael BLEOMELEN, Chevreuse (FR); Pierre JOLIVET, Thiverval-Grignon (FR); Matthieu PETITPAS, Rueil-Malmaison (FR); Julien GLORY, Antony (FR); Jean-Paul GONCALVES, Mérignac (FR); Julien OLLIVIER, Saint Rémy Les Chevreuse (FR)

(73) Assignee: GAZTRANSPORT ET TECHNIGAZ, Saint Rémy Les Chevreuse (FR)

(21) Appl. No.: 15/302,002

(22) PCT Filed: Apr. 3, 2015
(86) PCT No.: PCT/EP2015/097015

§ 371 Date: Oct. 5, 2016

(30) Foreign Application Priority Data
Apr. 8, 2014 (FR) 1453115

(51) Int. Cl. F17C 3/02; F17C 5/02; B63B 25/16; F17C 7/02; F17C 13/00; F17C 13/02

(52) U.S. Cl. CPC F17C 3/025; F17C 13/004; F17C 13/025; B63B 25/16; F17C 7/02; F17C 5/02; F17C 2203/0345; F17C 2203/0631; F17C 2205/0332; F17C 2205/0352; F17C 2221/033; F17C 2223/033; F17C 2250/043; F17C 2250/0452; F17C 2250/0626; F17C 2250/0473; F17C 2260/038; F17C 2270/0105; F17C 2227/0341

(57) ABSTRACT

A floating structure including a sealed and thermally insulated tank. An upper bearing wall bears a turret-like cargo tank dome intended for the passage of cargo handling equipment. The turret-like cargo tank dome with an internal fluidtight wall forming a sheath engaged through the opening in the upper bearing wall and connected in fluidtight manner to the primary sealing membrane of the upper tank wall all around the sheath. Respective primary and secondary venting devices allow gas to be vented respectively from the primary and secondary spaces of the turret-like cargo tank dome. A gas reservoir containing a tracer gas that is non-condensable or that has a condensation temperature below the low temperature of the liquefied gas contained in the tank is connected via a control valve to one of the venting devices that are the primary venting device and the secondary venting device.

### TECHNICAL FIELD

The invention relates to the field of sealed and thermally insulated tanks for storing a liquefied gas at a low temperature, and more particularly to devices and methods for detecting leaks in a secondary sealing membrane of such a tank.

### BACKGROUND

In a methane carrier ship tank, the upper wall of the tank has structures known as the vapor dome and the liquid dome which take the form of two turret-like structures projecting from an exterior surface of the upper bearing wall and intended for the passage of the cargo handling equipment for handling a liquid phase and a vapor phase of the liquefied gas contained in the tank.

Because of this geometry, leak detection methods based on observing zones that are abnormally hot or abnormally cold may fail to detect correctly, notably as a result of the influence of the exterior weather conditions and because the temperature fields in and around these turret-like cargo tank domes are highly complex.

### SUMMARY

One idea underlying the invention is that of providing devices and methods for detecting leaks in a sealed and thermally insulated tank in and around these projecting structures.

According to one embodiment, the invention provides a floating structure comprising a hull including bearing walls defining a polyhedral space inside the hull, the floating structure comprising a sealed and thermally insulated tank housed in the polyhedral space to store a low-temperature liquefied gas,

in which an upper bearing wall of the hull has an opening and bears a turret-like cargo tank dome projecting from an exterior surface of the upper bearing wall around the opening, the opening and the turret-like cargo tank dome being intended for the passage of cargo handling equipment for handling a liquid phase and/or a vapor phase of the liquefied gas contained in the tank,
in which the tank comprises a plurality of tank walls fixed to the bearing walls of the hull,
in which an upper tank wall comprises a multilayer structure fixed to an interior surface of the upper bearing wall, the multilayer structure being formed of a primary sealing membrane intended to be in contact with the liquefied gas contained in the tank, a secondary sealing membrane arranged between the primary sealing membrane and the upper bearing wall, a secondary insulating barrier positioned between the secondary sealing membrane and the upper bearing wall, and a primary insulating barrier positioned between the secondary sealing membrane and the primary sealing membrane,
in which the turret-like cargo tank dome comprises:

an internal fluidtight wall forming a sheath engaged through the opening of the upper bearing wall and connected in a fluidtight manner to the primary sealing membrane of the upper tank wall all around the sheath,

an external fluidtight wall arranged around the sheath some distance from the sheath parallel to the sheath, the external fluidtight wall being connected in a fluidtight manner to the upper bearing wall around the opening,

a dividing wall arranged between the external fluidtight wall and the internal fluidtight wall of the turret-like cargo tank dome and dividing the space defined between the external fluidtight wall and the internal fluidtight wall of the turret-like cargo tank dome into, on the one hand, a secondary space communicating through the opening of the upper bearing wall with the secondary insulating barrier of the upper tank wall arranged around the opening and, on the other hand, a primary space communicating through the opening of the upper bearing wall with the primary insulating barrier of the upper tank wall positioned around the opening,

a primary venting device comprising a primary overpressure relief valve and a primary venting pipe communicating directly with the primary space of the turret-like cargo tank dome and passing through the external fluidtight wall of the turret-like cargo tank dome in order to allow gas to be vented from the primary space in response to an opening of the primary overpressure relief valve,
a secondary venting device comprising a secondary overpressure relief valve and a secondary venting pipe communicating directly with the secondary space of the turret-like cargo tank dome and passing through the external fluidtight wall of the turret-like cargo tank dome to allow gas to be vented from the secondary space in response to an opening of the secondary overpressure relief valve,
the floating structure further comprising:
a gas reservoir containing a tracer gas that is non-condensable or that has a condensation temperature below the low temperature of the liquefied gas contained in the tank, the gas reservoir being connected via a control valve to one of the venting devices that are the primary venting device, notably the primary venting pipe, and the secondary venting device, notably the secondary venting pipe, and a gas detector able to detect the tracer gas, the gas detector being in communication with the other of the venting devices that are the primary venting device, notably the primary venting pipe, and the secondary venting device, notably the secondary venting pipe.

By virtue of these features it is possible to detect a lack of sealing between the primary space and the secondary space of the turret-like cargo tank dome and/or between the primary insulating barrier and the secondary insulating barrier of the upper tank wall. In addition, the use of the primary and secondary venting devices for injecting and detecting the tracer gas make implementing leak detection a particularly simple matter.

According to some embodiments, such a floating structure may comprise one or more of the following features.

The venting devices may be designed in different ways. According to one embodiment, the primary or secondary venting device further comprises a primary or secondary control line which communicates directly with the primary or secondary space of the turret-like cargo tank dome and which passes through the external fluidtight wall of the turret-like cargo tank dome to control the primary or secondary overpressure relief valve according to the pressure prevailing in the primary or secondary space, and the gas reservoir is in direct communication with the primary or secondary control line.

Alternatively, the gas reservoir may be connected directly to the primary or secondary venting pipe.

According to one embodiment, the primary or secondary venting device further comprises a primary or secondary control line which communicates directly with the primary or secondary space of the turret-like cargo tank dome and which passes through the external fluidtight wall of the turret-like cargo tank dome to control the primary or secondary overpressure relief valve according to the pressure prevailing in the primary or secondary space, and the gas detector is in direct communication with the primary or secondary control line.

Alternatively, the gas detector may be connected directly to the primary or secondary venting pipe.

According to one embodiment, the turret-like cargo tank dome is a vapor dome of the tank, the sheath engaged through the opening of the upper bearing wall being a collecting pipe connected to a main vapor manifold of the floating structure.

By virtue of these features, it is possible to detect a lack of sealing between the primary space and the secondary space of the vapor dome and/or between the primary insulating barrier and the secondary insulating barrier of the upper tank wall in the vicinity of the vapor dome.

The vapor dome may be designed in various ways. For preference, in this case, the dividing wall of the turret-like cargo tank dome forms a primary withdrawing pipe running parallel to the collecting pipe in the space defined between the external fluidtight wall and the internal fluidtight wall of the turret-like cargo tank dome and having an interior end opening into the primary insulating barrier of the upper tank wall and an exterior end opening directly into the primary venting device, the primary space of the turret-like cargo tank dome comprising the interior space of the primary withdrawing pipe.

According to another embodiment, the turret-like cargo tank dome is a liquid dome of the tank, further comprising a top wall positioned over an upper end of the external fluidtight wall of the liquid dome and having an opening aligned with a central zone of the opening of the upper bearing wall, the sheath formed by the internal fluidtight wall of the liquid dome being a primary sealing membrane having an upper edge attached in fluidtight manner to an edge of the top wall all around the opening of the top wall.

By virtue of these features, it is possible to detect a lack of sealing between the primary space and the secondary space of the liquid dome and/or between the primary insulating barrier and the secondary insulating barrier of the upper tank wall in the vicinity of the liquid dome.

The liquid dome may be designed in various ways. For preference, in this case, the dividing wall comprises a secondary sealing membrane extending all around the sheath between the external fluidtight wall and the sheath and having an interior end connected in fluidtight manner to the secondary sealing membrane of the upper tank wall all around the sheath and an exterior end connected in fluidtight manner to the top wall all around the opening of the top wall of the liquid dome.

According to one embodiment, the tank has the abovementioned arrangements both on the liquid dome and on the vapor dome so as to be able to detect leaks in these two zones of the tank.

According to one embodiment, the wall of the liquid dome comprises a multilayer structure fixed to an interior surface of the external fluidtight wall, the multilayer structure being formed of the primary sealing membrane of the liquid dome, the secondary sealing membrane of the liquid dome, a secondary insulating barrier of the liquid dome positioned between the secondary sealing membrane and the external fluidtight wall and a primary insulating barrier positioned between the secondary sealing membrane and the primary sealing membrane of the liquid dome.

For preference in this case, the floating structure further comprises a connecting plate positioned between the exterior end of the secondary sealing membrane of the liquid dome and the top wall, the connecting plate comprising a main leg running parallel to the external fluidtight wall between the external fluidtight wall and the sheath formed by the internal fluidtight wall of the liquid dome, the main leg comprising an upper end attached to the top plate and a lower end extended by a flange bent over toward the inside of the liquid dome with respect to the main leg, the exterior end of the secondary sealing membrane being attached in a fluidtight manner to the flange,

the secondary insulating barrier of the liquid dome comprises a fibrous filling placed between the main leg of the connecting plate and the external fluidtight wall, and
the secondary venting pipe opens into the fibrous filling.

By virtue of these features, the pressure drop induced by the fibrous filling in the zone of the secondary space into which the tracer gas is injected or from which the tracer gas is withdrawn is relatively small, making it easier for the tracer gas to circulate, notably around the liquid dome.

According to a corresponding embodiment, the primary venting pipe passes through the main leg of the connecting plate and opens into the primary insulating barrier between the main leg of the connecting plate and the primary sealing membrane of the liquid dome.

For preference, the floating structure further comprises a nitrogen distribution system including a gaseous-nitrogen reservoir and a distribution network, the distribution network comprising a primary distribution pipe extending from an upper deck of the floating structure through the primary space of the liquid dome and through the primary insulating barrier of a transverse wall of the tank as far as a bottom zone of the tank, and a secondary distribution pipe extending from the upper deck of the floating structure through the secondary space of the liquid dome and through the secondary insulating barrier of the transverse wall of the tank as far as the bottom zone of the tank.

Advantageously, the nitrogen distribution system further comprises pressure regulating means for regulating the pressure prevailing in the primary insulating barrier and the secondary insulating barrier of the walls of the tank by means of the primary and secondary distribution pipes.

By virtue of such pressure regulating means it is possible to avoid damaging the sealing barriers by the effect of accidental overpressures.

According to one embodiment, these pressure regulating means are used to generate a pressure difference between the zone into which the tracer gas is injected and the zone in which the tracer gas is looked-for, so as to reveal leaks or defective sealing more quickly.

Such a tank may be used to store all kinds of liquefied gases at atmospheric pressure, for example butane, propane, ethane, ethylene, methane and the like. According to one embodiment, the liquefied gas contained in the tank is liquefied natural gas (LNG), namely a gas with a high methane content, stored at a temperature of approximately −162° C.

Various chemical bodies can be used as tracer gas, notably according to the nature and temperature of the liquefied gas stored. According to one embodiment, particularly suited to an LNG tank, the tracer gas is selected from argon, helium and mixtures thereof.

According to one embodiment, the reservoir of tracer gas and/or the gas detector are fixed removably to the primary or secondary venting device. By virtue of these features it is possible to disconnect the reservoir of tracer gas and/or the gas detector from the access to the venting device to which it is fixed, for example a pipe or a pipe flange, so as to free up this access to the venting device for some other use outside of phases in which leak detection is being employed.

The invention also provides a method for operating an aforementioned floating structure, involving:

injecting the tracer gas through one of the primary and secondary venting devices into the primary or secondary space of the turret-like cargo tank dome without exceeding the pressure at which the primary or secondary overpressure relief valve opens,
detecting the tracer gas through the other of the primary and secondary venting devices in the primary or secondary space of the turret-like cargo tank dome and diagnosing a leak in the secondary sealing barrier of the tank upper wall and/or in the turret-like cargo tank dome dividing wall in response to the detection of the tracer gas.

According to one embodiment, the tracer gas is injected into the secondary space through the secondary venting device and is detected in the primary space through the primary venting device, the method further involving:

maintaining a higher total pressure in the secondary space than in the primary space by injecting gaseous nitrogen into the secondary space, without exceeding the pressure at which the secondary overpressure relief valve opens.

The reverse usage is also possible, in which the tracer gas is injected into the primary space through the primary venting device and is detected in the secondary space through the secondary venting device. In that case, the pressure levels can be reversed.

According to one embodiment, the step of diagnosing a leak comprises one of the measures selected from the group involving logging the presence of a leak, measuring a quantity or concentration of the tracer gas in order to determine a flow rate of the leak, and measuring a time delay between the injection and detection of the tracer gas in order to determine a position of the leak.

Such a tank may form part of an on-shore storage facility, for example for storing LNG, or may be installed in an in-shore or off-shore floating structure, notably a methane carrier ship, a floating storage and regasification unit (SRFU), a floating production, storage and offloading (FPSO) unit and the like.

According to one embodiment, the invention also provides a method for the loading of, or offloading from, such a floating structure, in which liquefied gas is brought through insulated pipelines from or to a floating or on-shore storage facility to or from the sealed and thermally insulated tank.

According to one embodiment, the invention also provides a transfer system for low-temperature liquefied gas, the system comprising an aforementioned floating structure, insulated pipelines designed to connect the sealed and thermally insulated tank to a floating or on-shore storage facility and a pump for driving a flow of cold liquid product through the insulated pipelines from or to the floating or on-shore storage facility to or from the tank of the carrier ship.

Certain aspects of the invention are based on the concept of limiting the distance that the tracer gas has to cover between the point of injection and the point of detection, so that detection of leaks in the turret-like cargo tank dome zone can be performed relatively quickly and with a relatively small quantity of tracer gas compared with the volume of all of the walls of the tank. Certain aspects of the invention are based on the concept of offering a test method that can be performed at sea with the tank cold, so as to avoid having to take the floating structure out of action into a dry dock.

### BRIEF DESCRIPTION OF THE DRAWINGS

The invention will be better understood and further objects, details, features and advantages thereof will become more clearly apparent during the course of the following description of a number of particular embodiments of the invention, which are given solely by way of nonlimiting illustration with reference to the attached drawings.

FIG. 1 is a functional diagram of a tank of a methane carrier ship viewed in cross section on a longitudinal axis of the ship.

FIG. 2 is a functional diagram of a liquid dome of the tank of FIG. 1, viewed from above.

FIG. 3 is an isometric perspective view with cutaway of a transverse wall delimiting a front side of the liquid dome of FIG. 2.

FIG. 4 is an enlarged view of zone IV of FIG. 1, according to one embodiment.

FIG. 5 is a functional diagram of a vapor dome of the tank of FIG. 1, viewed from above.

FIG. 6 is an enlarged view of zone VI of FIG. 1, according to one embodiment.

FIG. 7 is a schematic depiction with cutaway of a tank of a methane carrier ship and of a terminal for the loading of/offloading from this tank.

### DETAILED DESCRIPTION OF EMBODIMENTS

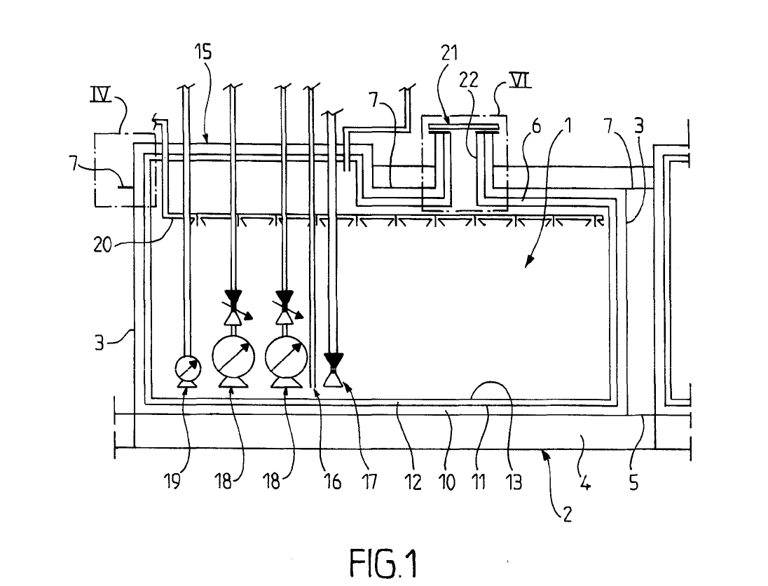

Reference is made to FIG. 1 which schematically depicts a longitudinal section through the hull 2 of a methane carrier ship in which a sealed and insulated tank 1 produced according to the membrane tank technology is placed.

The tank 1 is placed between two transverse partitions 3 generally referred to as “cofferdams” which divide the interior space of the hull into a plurality of polyhedral compartments each intended to accommodate a respective tank. A ship may thus comprise one or several similar tanks, as sketched out in the right-hand part of FIG. 1.

The hull 2 is a double wall delimiting a ballast space depicted by the numeral 4 for the lower part of the tank. The tank 1 is constructed on the internal wall 5 of the hull 2 which acts as a bearing wall. The upper wall 6 of the tank 1 is similarly borne by an upper bearing wall 7 that forms part of the hull 2.

The tank 1 has a polyhedral overall geometry and all the walls of the tank are made up of a multilayer structure which is known from elsewhere in the art of membrane tanks. It need merely be recalled that this multilayer structure comprises in succession a secondary insulating barrier 10, a secondary sealed membrane 11, a primary insulating barrier 12 and a primary sealed membrane 13 which directly contains the LNG stored in the tank 1. This multilayer structure can be produced according to various techniques, for example techniques marketed by the applicant company under the trade name Mark III®.

FIG. 1 reveals that the upper bearing wall 7 is interrupted at two locations where the tank wall forms a projecting turret-like or chimney-like structure. The first turret-like cargo tank dome is a liquid dome 15 which acts as the point of entry for various LNG handling equipment, namely, in the example depicted, a filling line 16, an emergency pumping line 17, offloading lines connected to offloading pumps 18, a spray line 20 and a feed line connected to a spray pump 19. The second turret-like cargo tank dome is a vapor dome 21 which serves as a point of entry for a vapor collecting pipe 22. The way in which this equipment works is known from elsewhere.

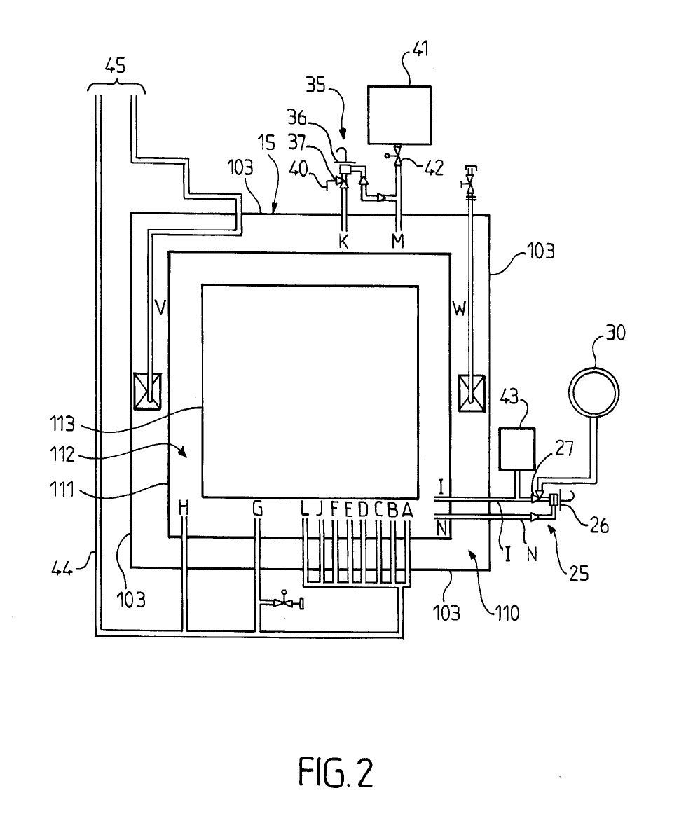

Features of the liquid dome 15 will now be described in greater detail with reference to FIGS. 2 to 4. Elements which are analogous or identical to those of FIG. 1 bear the same reference numeral increased by 100.

As is best visible in FIG. 2, the liquid dome is of square cross section made up of four similar vertical walls each of which again includes the aforementioned multilayer structure, namely bearing wall 103, secondary insulating barrier 110, secondary sealed membrane 111, primary insulating barrier 112 and primary sealed membrane 113.

Because the sealing membranes 111 and 113 are relatively fragile elements that are not designed to withstand high pull-out forces, the liquid dome is equipped with a primary venting device 25 to protect the primary sealed membrane 113 against overpressures and with a secondary venting device 35 to protect the secondary sealed membrane 111 against overpressures.

More specifically, the primary venting device 25 comprises a venting pipe I opening at one end inside the primary insulating barrier 112 of the liquid dome and at the other end into a vent mast 30 arranged on the outside on the deck of the ship and venting to the atmosphere. An overpressure relief valve 27 is arranged on the pipe I, and its default status is closed. The relief valve 27 opens under the command of a valve driver 26 when the total pressure in the primary insulating barrier 112 exceeds a predefined level, for example 30 mbar, namely 3 kPa. The valve driver 26 is connected to the pressure of the primary insulating barrier 112 by a control line N. Thus, the gaseous phase present in the primary insulating barrier 112 is vented automatically to the vent mast 30 when its pressure exceeds the predefined level.

In the same way, the secondary venting device 35 comprises a venting pipe K opening at one end inside the secondary insulating barrier 110 of the liquid dome and at the other end into a venting line 40 venting to the atmosphere. An overpressure relief valve 37 is arranged on the pipe K, and its default status is closed. The relief valve 37 opens under the control of a valve driver 36 when the total pressure in the secondary insulating barrier 110 exceeds a predefined level, for example 30 mbar, namely 3 kPa. The valve driver 36 is connected to the pressure of the secondary insulating barrier 110 by a control line M. Thus, the gaseous phase present in the secondary insulating barrier 110 is automatically vented to the venting line 40 when its pressure exceeds the predefined level. The pressures at which the valves 27 and 37 open may be equal or may be different.

In order to detect leaks or defects in sealing in the secondary sealed membrane 111 at the liquid dome 15, a device for injecting and detecting a tracer gas is used in the liquid dome 15. This device comprises a tracer gas reservoir 41 which is connected to the control line M via a valve 42, so that tracer gas can be transferred to the secondary insulating barrier 110 when the valve 42 is open. The tracer gas is, for example, argon or helium or any other gas or mixture of gases which does not carry the risk of liquefying while being used.

This device also comprises a gas detector 43 capable of detecting the tracer gas and connected to the venting pipe I, so as to be able to detect the presence of the tracer gas in the gaseous phase present in the primary insulating barrier 112.

The fundamental principle of the detection is as follows: given that the secondary sealed membrane 111 is supposed to isolate the secondary insulating barrier 110 from the primary insulating barrier 112 in a gastight manner, positive detection of tracer gas in the primary insulating barrier 112 when this gas has been injected only into the secondary insulating barrier 110 has to mean that a leak is present.

Alternatively, the reservoir 41 can be connected up to the pipeline K and/or the detector 43 can be connected up to the pipeline N without altering the principle of operation.

FIG. 2 also shows nitrogen supply lines which enter the tank at the liquid dome in order to allow control over the total pressure in the secondary 110 and primary 112 insulating barriers. These supply lines come from a gaseous nitrogen-gas reservoir symbolized by the numeral 45. They include a secondary nitrogen line V opening into the secondary insulating barrier 110 at the bottom of the tank and a primary nitrogen line 44 which splits into multiple nitrogen distribution lines A, B, C, D, E, F, G, H, J, L all opening into the primary insulating barrier 112 at the bottom of the tank.

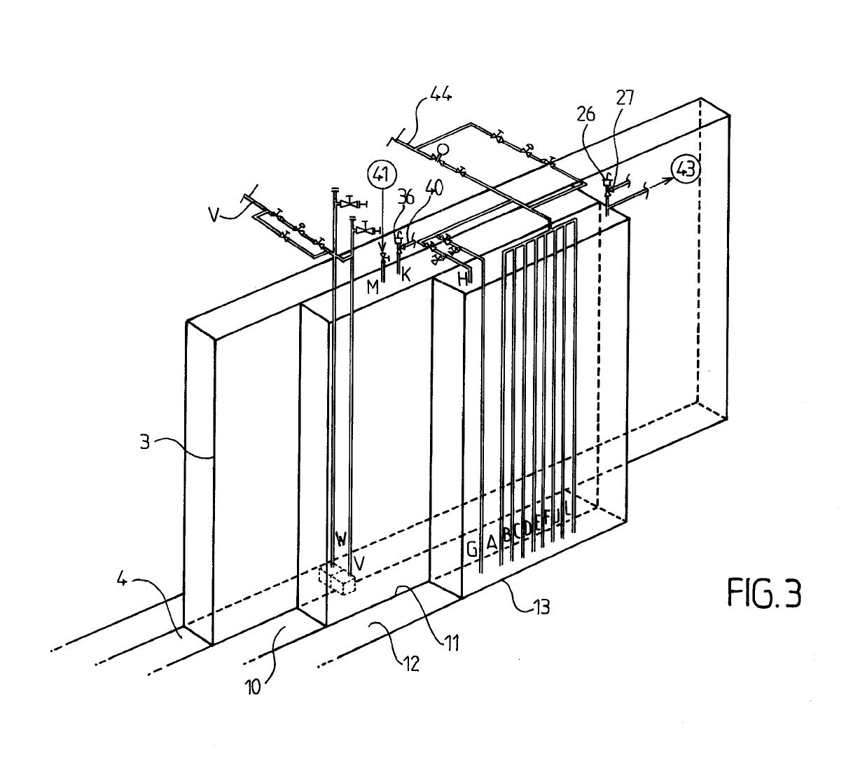

FIG. 3 shows other specifics regarding the possible routing of the gaseous nitrogen-gas supply lines in the tank wall. It notably shows that these lines open at the bottom of the tank a fairly long distance away from the liquid dome and from the vapor dome. The gaseous nitrogen-gas supply lines may notably be used to inert the tank walls and regulate the total pressure in these tanks, by means of a pressure regulating system which is known from elsewhere.

This pressure regulating system can be put to use to improve the operation of the leak detection system. According to a corresponding embodiment, leak detection can be implemented as follows:
Injecting the tracer gas into the secondary space 110 of the liquid dome.
Regulating the pressure to a level slightly higher in the secondary space 110 than in the primary space 112, preferably without reaching the pressure at which the secondary venting relief valve 37 opens, so as to avoid damaging the secondary membrane 111. These two steps may also be performed simultaneously or in a different order.
Detecting the presence of the tracer gas in the primary space 112.

Thanks to the slight pressure difference, the transfer of tracer gas can be accelerated, making it possible to reduce the duration of the leak detection test. For example, the pressure in the primary barrier is set at 10 mbar (100 kPa) gauge and the pressure in the secondary barrier is set at 17 mbar (170 kPa) gauge, giving a difference of 70 kPa. This difference may be higher, for example up to 250 kPa, in order to accelerate the implementation of the test. The full duration of the test may thus be shorter than 4 hours per dome, and preferably of the order of 60 minutes.

In an embodiment that is not depicted, the positions of the gas detector 43 and of the tracer gas reservoir 41 are swapped over, and the pressure differences are reversed.

The gas detector may be a gas analyzer which is commercially available, operating using any suitable technology, for example using mass spectrometry or some other technique. In order to refine the diagnosis of the leaks it is preferable to measure the concentration of tracer gas present in the primary space 112 over the course of time. Thus, the duration and the quantity of tracer gas make it possible to obtain information about:
the existence of a leak, if tracer gas is detected in non-insignificant quantities,
the flow rate of the leak or leaks, by integrating the quantity of tracer gas with respect to time,
the location of the leak or leaks on the liquid dome, by measuring the time of first detection of tracer gas with respect to the time corresponding to the path through the insulating barriers.

Given that the tank wall in the liquid dome has a volume that is relatively small by comparison with the tank as a whole, for example around 2 m³, the leak test can be performed using a relatively small volume of tracer gas, for example approximately 3 m³ of argon.

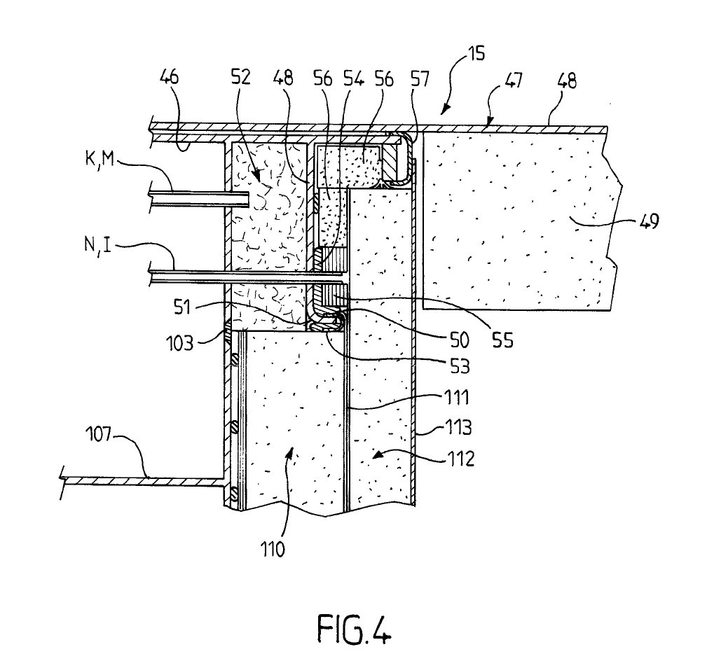

FIG. 4 shows other details of embodiment of the liquid dome 15 in an embodiment employing Mark III® technology. For the sake of conciseness, only one pipe has been depicted to illustrate the pipeline K or M of the secondary venting device 35, and only one pipe has been depicted to illustrate the pipeline N or I of the primary venting device 25. In addition, these pipes have been depicted in the same plane. However, in a real embodiment there will indeed be four of these pipelines and they do not necessarily have to be in the same plane, as FIG. 2 shows. In addition, it is possible to provide one or several additional tracer gas injection points in order to improve the speed at which the test can be carried out, notably in the case of a large-sized liquid dome. These additional injection points may be distributed uniformly around the periphery of the liquid dome 15.

In the liquid dome 15 of FIG. 4, the bearing structure comprises a vertical bearing wall 103 known as a coaming which stands up above the deck 107 of the ship and a horizontal wall 46 at the top of the bearing wall 103. The horizontal wall 46 extends all around the liquid dome and supports a tank lid 47. The lid 47 is made up essentially of a metal lid wall 48 and of thermal insulation 49 inserted in the top of the liquid dome.

The horizontal wall 46 bears an L-shaped profiled metal plate 48 which is welded to the interior face of the wall 46 and extends downward. Prefabricated panels are fixed to the bearing wall 103 to form the primary thermally insulating barrier, the secondary sealing barrier and the secondary thermally insulating barrier.

In the zone at which the secondary membrane 111 stops, a flexible fluidtight composite layer 50 connects the fluidtight layer of the prefabricated panel in a fluidtight manner to the bent-over flange 51 of the plate 48. The bonding of the layer 50 to the flange 51 is performed using a suitable adhesive, for example of the polyurethane type.

A glass wool filling 52 is inserted between the metal plate 48 and the bearing wall 103 to extend the secondary insulating barrier 110, which is essentially made of insulating foam panels. A coat of mastic 53, for example made of epoxy resin, is compressed between the lower face of the flange 51 and the last insulating foam panel in order to fix and accurately position the panel. A second coat of mastic 54, for example also made of epoxy resin, is borne by the upper face of the flange 51 and becomes compressed between the flange 51 and a wooden joist 55 which is positioned horizontally along the plate 48. The joist 55 may be bolted to the plate 20. Other blocks of insulating foam 56 are positioned between the top of the joist 55 and the horizontal wall 46 of the bearing structure to extend the primary insulating barrier.

The end of the primary sealing barrier 113 is fixed in a fluidtight manner to the bearing structure by welding to a U-section profiled component 57 which is borne by the end of the horizontal wall 46.

In this embodiment, the glass wool filling 52, which goes all around the liquid dome, constitutes a favored zone for the passage of tracer gas that has found its way through a leak, because of the low pressure drop. Thus, it is possible to detect leaks at any point around the liquid dome even with just one or a small number of gas detection points.

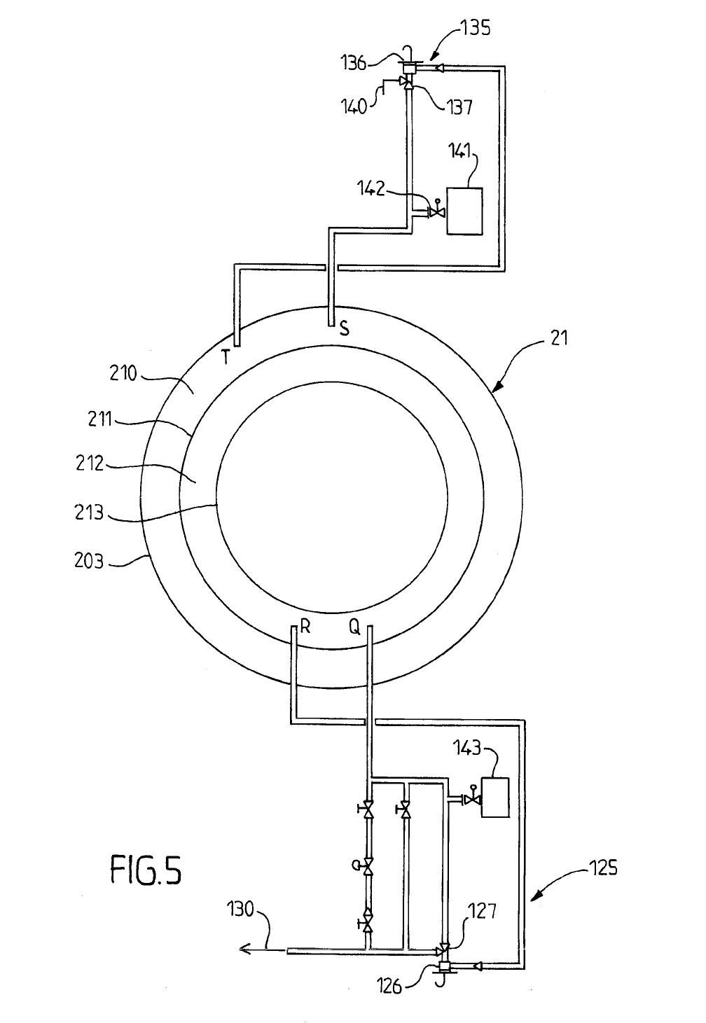

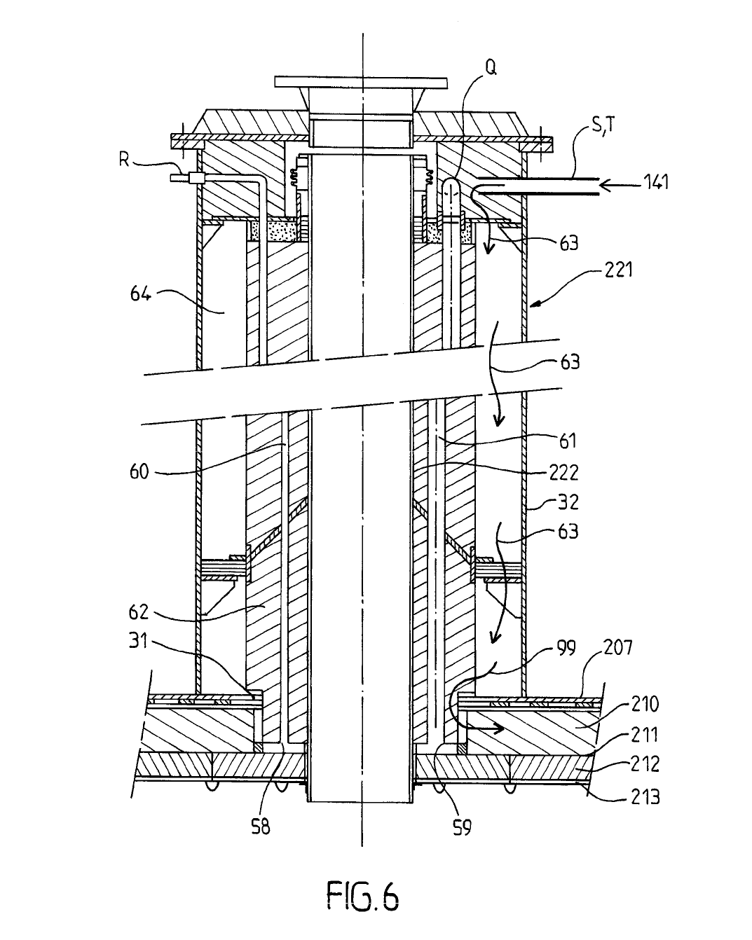

The methods described hereinabove for detecting leaks in a liquid dome can be employed in the same way in a vapor dome, as will now be described with reference to FIGS. 5 and 6.

As best visible in FIG. 5, the vapor dome has a circular cross section in which we again find, at least functionally, the aforementioned multilayer structure, namely bearing wall 203, secondary insulating barrier 210, secondary sealed membrane 211, primary insulating barrier 212 and primary sealed membrane 213.

Because the sealing membranes 211 and 213 are relatively fragile elements that are not designed to withstand high pull-out forces, the vapor dome is equipped with a primary venting device 125 to protect the primary sealed membrane 213 against overpressures and with a secondary venting device 135 to protect the secondary sealed membrane 211 against overpressures.

More specifically, the primary venting device 125 comprises a venting pipe Q opening at one end inside the primary insulating barrier 212 of the vapor dome and at the other end into the vent mast 30 of FIG. 2 that vents to the atmosphere, as symbolized by the arrow 130 of FIG. 5. An overpressure relief valve 127 is arranged on the pipe Q, and its default status is closed. The relief valve 127 opens under the control of a valve driver 126 when the total pressure in the primary insulating barrier 212 exceeds a predefined level, for example 30 mbar, namely 3 kPa. The valve driver 126 is connected to the pressure of the primary insulating barrier 212 by a control line R. Thus, the gaseous phase present in the primary insulating barrier 212 is automatically vented to the vent mast 30 when its pressure exceeds the predefined level.

In the same way, the secondary venting device 135 comprises a venting pipe S opening at one end inside the secondary insulating barrier 210 of the vapor dome and at the other end into a venting line 140 venting to the atmosphere. An overpressure relief valve 137 is arranged on the pipe S, and its default status is closed. The relief valve 137 opens under the control of a valve driver 136 when the total pressure in the secondary insulating barrier 210 exceeds a predefined level, for example 30 mbar, namely 3 kPa. The valve driver 136 is connected to the pressure of the secondary insulating barrier 210 by a control line T. Thus, the gaseous phase present in the secondary insulating barrier 210 is automatically vented to the venting line 140 when its pressure exceeds the predefined level. The pressures at which the valves 127 and 137 open may be equal or may be different.

In order to detect leaks or defective sealing in the secondary sealed membrane 211 in the region of the vapor dome 21, a device for injecting and detecting a tracer gas is employed. This device comprises a tracer gas reservoir 141 which is connected to the venting pipe S via a valve 142 so that tracer gas can be transferred to the secondary insulating barrier 210 when the valve 142 is open. The tracer gas is, for example, argon or helium or any other gas or mixture of gases that does not carry the risk of liquefying while being used.

This device likewise comprises a gas detector 143 capable of detecting the tracer gas and connected to the venting pipe Q, so as to be able to detect the presence of tracer gas in the gaseous phase present in the primary insulating barrier 212.

As far as the rest is concerned, detection of leaks in the vapor dome works in exactly the same way as for the liquid dome described above.

FIG. 6 shows other embodiment details of the vapor dome 221 in an embodiment using Mark III® technology. Elements analogous or identical to those of FIG. 1 bear the same reference numeral increased by 200.

For the sake of conciseness, just one pipe has been depicted to illustrate the pipe S or T of the secondary venting device 135. In addition, this pipe has been depicted in the same plane as the pipe lines R and Q of the primary venting device 125. However, in a real embodiment there are indeed four of these pipelines Q, R, S, T and they do not necessarily have to be in the same plane, as FIG. 5 shows. In addition, it is possible to provide one or several additional tracer gas injection points in order to improve the speed at which the test can be carried out, notably in the case of a large-sized vapor dome. These additional injection points may be distributed evenly around the periphery of the vapor dome 221.

In the vapor dome 221 of FIG. 6, the upper bearing wall 207 comprises a circular opening 31 around which is welded a barrel 32 which extends out from the upper bearing wall 207. A vapor collecting metal pipe 222 is anchored inside the barrel 32 and is intended to extract vapors produced by evaporation of the fluid in the tank. For that purpose, the collecting pipe 222 passes through the tank wall at the center of the circular opening 31 and the sealed membranes 211 and 213 and the insulating barriers 210 and 212 in order to open into the tank. This collecting pipe 222 is notably connected to a vapor manifold on the outside of the tank which extracts this vapor and transmits it for example to the carrier ship propulsion device to fuel the propulsion of the ship or to a liquefaction device so that the fluid can then be reintroduced back into the tank.

The primary sealing barrier 213 is connected in a fluidtight manner to the collecting pipe 222. Likewise, the secondary sealing barrier 211 is connected in a fluidtight manner to the collecting pipe 222 except at two passages 58 and 59 that allow the fluid present between the two sealing barriers to circulate toward withdrawing pipes 60 and 61. The absence of the secondary sealed membrane at this point is symbolized by the broken lines in the passages 58 and 59. In this way, the space between the secondary sealed barrier 211 and the primary sealed barrier 213 forms a fluidtight primary space which is connected to the two venting pipes 60 and 61.

Moreover, the barrel 32 is connected in a fluidtight manner to the upper bearing wall 7 and to the collecting pipe 222. The collecting pipe comprises an insulating layer 62 distributed uniformly over its exterior span which has a diameter smaller than the circular opening 31. In this way, the spacing between the insulating layer 62 and the circular opening 31 allows gas to circulate between the secondary insulating barrier 210 and an intermediate space 64 present between the barrel 32 and the layer of insulation 62, as indicated by the arrow 99. The intermediate space and the secondary insulating barrier 210 thus form a secondary fluidtight space.

The two withdrawing pipes 60 and 61 run parallel to the collecting pipe 222 in the insulating layer 62 from outside the barrel 32 as far as the primary fluidtight space. The pipe 61 opens into the pipe Q of FIG. 5 and creates a passage between the primary fluidtight space and the overpressure relief valve not depicted. The pipe 60 opens into the pipe R of FIG. 5 and creates a passage between the primary space and the valve driver not depicted. Two other pipes depicted by the references S, T are welded to the barrel 32 and open into the barrel 32 in the secondary fluidtight space so that they too can manage the flow of fluids and the measurement of pressure in the secondary fluidtight space.

It will be noted that, in the barrel 32 of the vapor dome 221, the structure of the tank wall is not strictly a multilayer structure as found in the walls of the tank, because the primary space here is limited to the cross section for the passage of two withdrawing pipes 60 and 61 which pass completely into the secondary space. However, the structure is still that of a primary space and of a secondary space assumed to be isolated from one another by a gastight partition so that the leak detection tests described above still maintain their full significance in this slightly different structure.

The abovementioned leak detection methods can be implemented in the vapor dome 221 of FIG. 6 by injecting tracer gas through the pipe S or T and detecting the tracer gas through the pipe Q or R. The arrows 63 in FIG. 6 schematically illustrate the path followed by the tracer gas in the intermediate space 64 between the pipe S or T which injects the tracer gas and the secondary insulating barrier 210 of the tank upper wall that it may penetrate.

Other details regarding the installation of a vapor dome may be found in publication FR-A-2984454.

The technique described hereinabove for creating a device for detecting leaks in a projecting part of the tank wall can be used in different types of reservoir, for example to constitute the liquid dome or the vapor dome of an LNG reservoir in an on-shore facility or in a floating structure such as a methane carrier ship or the like.

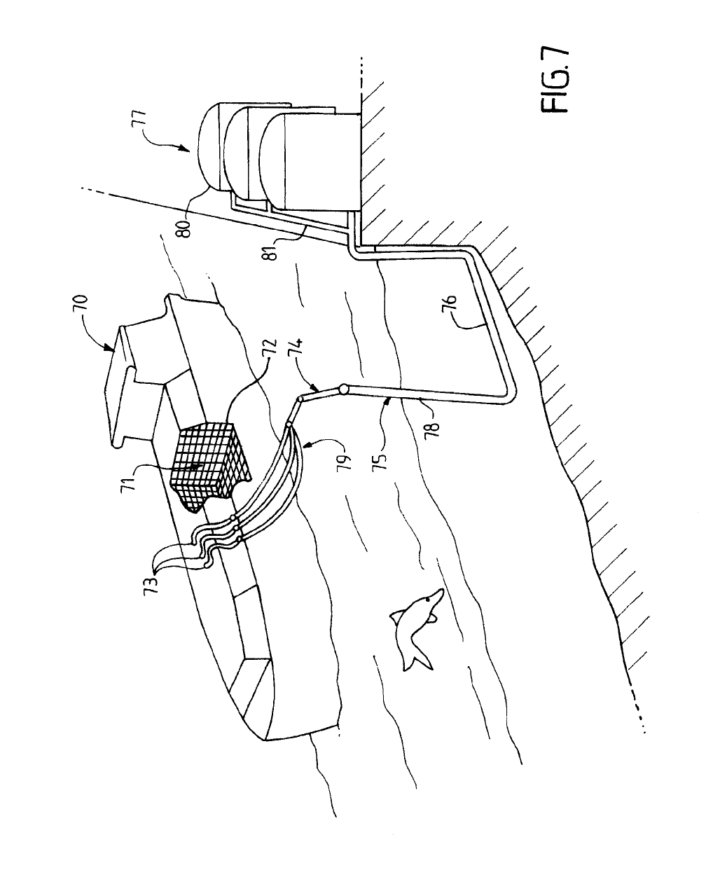

With reference to FIG. 7, a cutaway view of a methane carrier ship 70 shows a sealed and insulated tank 71 of prismatic overall shape mounted in the double hull 72 of the ship. The wall of the tank 71 comprises a primary sealed barrier intended to be in contact with the LNG contained in the tank, a secondary sealed barrier arranged between the primary sealed barrier and the double hull 72 of the ship, and two insulating barriers respectively arranged between the primary sealed barrier and the secondary sealed barrier and between the secondary sealed barrier and the double hull 72.

In a way known per se, loading/offloading pipelines 73 placed on the upper deck of the ship may be connected, using suitable connectors, to a maritime or harbor-based terminal for transferring a cargo of LNG from or to the tank 71.

FIG. 7 depicts one example of a maritime terminal comprising a loading and offloading station 75, an underwater pipe 76 and a shore-based facility 77. The loading and offloading station 75 is a fixed offshore facility comprising a mobile arm 74 and a tower 78 supporting the mobile arm 74. The mobile arm 74 bears a bundle of insulated flexible pipes 79 which can be connected to the loading/offloading pipelines 73. The orientable mobile arm 74 adapts to suit all sizes of methane carrier ship. A connecting pipe, not depicted, extends along inside the tower 78. The loading and offloading station 75 allows the loading of and the offloading from the methane carrier ship 70 from or to the shore-based facility 77. The latter comprises liquefied gas storage tanks 80 and connecting pipes 81 connected by the underwater pipe 76 to the loading or offloading station 75. The underwater pipe 76 allows the liquefied gas to be transferred between the loading or offloading station 75 and the on-shore facility 77 over a long distance, for example 5 km, which means that the methane carrier ship 70 can be kept a long way off shore during the loading and offloading operations.

In order to generate the pressure necessary for transferring the liquefied gas, use is made of pumps carried on board the ship 70 and/or of pumps with which the shore-based facility 77 is equipped and/or of pumps with which the loading and offloading station 75 is equipped.

Although the invention has been described in conjunction with a number of particular embodiments, it is quite obvious that it is not in any way restricted thereto and that it encompasses all technical equivalents of the means described and combinations thereof where these fall within the scope of the invention.

The use of the verbs “comprise”, “involve” or “have” and conjugated forms thereof does not exclude the presence of other elements or other steps than those listed in a claim. The use of the indefinite article “a” or “an” in an element or a step does not, unless mentioned otherwise, preclude there being a plurality of such elements or steps.

In the claims, no reference sign between parentheses should be interpreted as imposing a limitation on the claim.

1. A floating structure comprising a hull including bearing walls (3, 5, 7) defining a polyhedral space inside the hull, the floating structure comprising a sealed and thermally insulated tank (1) housed in the polyhedral space to store a low-temperature liquefied gas,
in which an upper bearing wall (7, 107) of the hull has an opening and bears a turret-like cargo tank dome (15, 21, 221) projecting from an exterior surface of the upper bearing wall around the opening, the opening and the turret-like cargo tank dome being intended for the passage of cargo handling equipment (16, 22, 222) for handling a liquid phase and/or a vapor phase of the liquefied gas contained in the tank,
in which the tank comprises a plurality of tank walls fixed to the bearing walls of the hull, in which an upper tank wall comprises a multilayer structure fixed to an interior surface of the upper bearing wall, the multilayer structure being formed of a primary sealing membrane (13, 113, 213) intended to be in contact with the liquefied gas contained in the tank, a secondary sealing membrane (11, 111, 211) arranged between the primary sealing membrane and the upper bearing wall, a secondary insulating barrier (10, 110, 210) positioned between the secondary sealing membrane and the upper bearing wall, and a primary insulating barrier (12, 112, 212) positioned between the secondary sealing membrane and the primary sealing membrane,
in which the turret-like cargo tank dome comprises:
an internal fluidtight wall forming a sheath (113, 222) engaged through the opening of the upper bearing wall (7, 107, 207) and connected in a fluidtight manner to the primary sealing membrane (13, 213) of the upper tank wall all around the sheath,
an external fluidtight wall (103, 32) arranged around the sheath some distance from the sheath parallel to the sheath, the external fluidtight wall being connected in fluidtight manner to the upper bearing wall around the opening,
a dividing wall (111, 60, 61) arranged between the external fluidtight wall (103, 32) and the internal fluidtight wall (113, 222) of the turret-like cargo tank dome and dividing the space defined between the external fluidtight wall and the internal fluidtight wall of the turret-like cargo tank dome into, on the one hand, a secondary space (110, 62, 64) communicating through the opening of the upper bearing wall with the secondary insulating barrier (10, 210) of the upper tank wall arranged around the opening and, on the other hand, a primary space (112, 60, 61) communicating through the opening of the upper bearing wall with the primary insulating barrier (12, 212) of the upper tank wall positioned around the opening,
a primary venting device (25, 125) comprising a primary overpressure relief valve (27, 127) and a primary venting pipe (I, Q) communicating directly with the primary space of the turret-like cargo tank dome and passing through the external fluidtight wall of the turret-like cargo tank dome in order to allow gas to be vented from the primary space in response to an opening of the primary overpressure relief valve,
a secondary venting device (35, 135) comprising a secondary overpressure relief valve (37, 137) and a secondary venting pipe (K, S) communicating directly with the secondary space of the turret-like cargo tank dome and passing through the external fluidtight wall of the turret-like cargo tank dome to allow gas to be vented from the secondary space in response to an opening of the secondary overpressure relief valve,
the floating structure further comprising:
a gas reservoir (41, 141) containing a tracer gas that is non-condensable or that has a condensation temperature below the low temperature of the liquefied gas contained in the tank, the gas reservoir being connected via a control valve (42, 142) to one of the venting devices that are the primary venting device and the secondary venting device, and a gas detector (43, 143) able to detect the tracer gas, the gas detector being in communication with the other of the venting devices that are the primary venting device, notably the primary venting pipe, and the secondary venting device, notably the secondary venting pipe.

2. The floating structure as claimed in claim 1, in which the primary or secondary venting device further comprises a primary or secondary control line (M, N, R, T) which communicates directly with the primary or secondary space of the turret-like cargo tank dome and which passes through the external fluidtight wall of the turret-like cargo tank dome to control the primary or secondary overpressure relief valve according to the pressure prevailing in the primary or secondary space, and in which the gas reservoir (41, 141) is in direct communication with the primary or secondary control line.

3. The floating structure as claimed in claim 1, in which the primary or secondary venting device further comprises a primary or secondary control line (M, N, R, T) which communicates directly with the primary or secondary space of the turret-like cargo tank dome and which passes through the external fluidtight wall of the turret-like cargo tank dome to control the primary or secondary overpressure relief valve according to the pressure prevailing in the primary or secondary space, and in which the gas detector (43, 143) is in direct communication with the primary or secondary control line.

4. The floating structure as claimed in claim 1, in which the turret-like cargo tank dome is a vapor dome (221) of the tank, the sheath engaged through the opening of the upper bearing wall being a collecting pipe (22, 222) connected to a main vapor manifold of the floating structure, and in which the dividing wall of the turret-like cargo tank dome forms a primary withdrawing pipe (60, 61) running parallel to the collecting pipe in the space defined between the external fluidtight wall (32) and the internal fluidtight wall (222) of the turret-like cargo tank dome and having an interior end (58, 59) opening into the primary insulating barrier of the upper tank wall and an exterior end (Q, R) opening directly into the primary venting device (125), the primary space of the turret-like cargo tank dome comprising the interior space of the primary withdrawing pipe.

5. The floating structure as claimed in claim 1, in which the turret-like cargo tank dome is a liquid dome (15) of the tank, further comprising a top wall (46) positioned over an upper end of the external fluidtight wall (103) of the liquid dome and having an opening aligned with a central zone of the opening of the upper bearing wall, the sheath formed by the internal fluidtight wall (113) of the liquid dome being a primary sealing membrane having an upper edge attached in fluidtight manner to an edge (57) of the top wall all around the opening of the top wall, and in which the dividing wall comprises a secondary sealing membrane (111) extending all around the sheath between the external fluidtight wall and the sheath (113) and having an interior end connected in fluidtight manner to the secondary sealing membrane (11) of the upper tank wall all around the sheath and an exterior end (50) connected in fluidtight manner to the top wall (46) all around the opening of the top wall of the liquid dome.

6. The floating structure as claimed in claim 5, in which the wall of the liquid dome (15) comprises a multilayer structure fixed to an interior surface of the external fluidtight wall, the multilayer structure being formed of the primary sealing membrane (113) of the liquid dome, the secondary sealing membrane (111) of the liquid dome, a secondary insulating barrier (110) of the liquid dome positioned between the secondary sealing membrane and the external fluidtight wall and a primary insulating barrier (112) positioned between the secondary sealing membrane and the primary sealing membrane of the liquid dome.

7. The floating structure as claimed in claim 6, further comprising a connecting plate (48) positioned between the exterior end (50) of the secondary sealing membrane of the liquid dome and the top wall (46), the connecting plate comprising a main leg running parallel to the external fluidtight wall between the external fluidtight wall and the sheath formed by the internal fluidtight wall of the liquid dome, the main leg comprising an upper end attached to the top plate (46) and a lower end extended by a flange (51) bent over toward the inside of the liquid dome with respect to the main leg, the exterior end (50) of the secondary sealing membrane being attached in a fluidtight manner to the flange (51),
in which the secondary insulating barrier of the liquid dome comprises a fibrous filling (52) placed between the main leg of the connecting plate (48) and the external fluidtight wall (103), and
in which the secondary venting pipe (K, M) opens into the fibrous filling.

8. The floating structure as claimed in claim 7, in which the primary venting pipe (N, I) passes through the main leg of the connecting plate (48) and opens into the primary insulating barrier between the main leg of the connecting plate and the primary sealing membrane (113) of the liquid dome.

9. The floating structure as claimed in claim 5, further comprising a nitrogen distribution system including a gaseous-nitrogen reservoir (45) and a distribution network, the distribution network comprising a primary distribution pipe (44, A-G, L, J) extending from an upper deck of the floating structure through the primary space (112) of the liquid dome and through the primary insulating barrier (12) of a transverse wall of the tank as far as a bottom zone of the tank, and a secondary distribution pipe (V) extending from the upper deck of the floating structure through the secondary space (110) of the liquid dome and through the secondary insulating barrier of the transverse wall of the tank as far as the bottom zone of the tank, and
in which the nitrogen distribution system further comprises pressure regulating means for regulating the pressure prevailing in the primary insulating barrier and the secondary insulating barrier of the walls of the tank by means of the primary and secondary distribution pipes.

10. The floating structure as claimed in claim 1, in which the tracer gas is selected from argon, helium and mixtures thereof.

11. The floating structure as claimed in claim 1, in which the tracer gas reservoir (41, 141) is fixed removably to the primary or secondary venting device.

12. A method for operating a floating structure as claimed in claim 1, involving:
injecting the tracer gas through one of the primary and secondary venting devices (25, 125, 35, 135) into the primary or secondary space of the turret-like cargo tank dome (15, 221) of the floating structure without exceeding the pressure at which the primary or secondary overpressure relief valve opens,
detecting the tracer gas through the other of the primary and secondary venting devices (25, 125, 35, 135) in the primary or secondary space of the turret-like cargo tank dome and diagnosing a leak in the secondary sealing barrier (11, 211) of the tank upper wall and/or in the turret-like cargo tank dome dividing wall (111, 60, 61) in response to the detection of the tracer gas.

13. The method as claimed in claim 12, in which the tracer gas is injected into the secondary space through the secondary venting device (35, 135) and is detected in the primary space through the primary venting device (25, 125), the method further involving:
maintaining a higher total pressure in the secondary space (110, 210) than in the primary space (112, 212) by injecting gaseous nitrogen into the secondary space, without exceeding the pressure at which the secondary overpressure relief valve opens.

14. The method as claimed in claim 12, in which the step of diagnosing a leak comprises one of the measures selected from the group involving logging the presence of a leak, measuring a quantity or concentration of the tracer gas in order to determine a flow rate of the leak, and measuring a time delay between the injection and detection of the tracer gas in order to determine a position of the leak.

15. A method for the loading of, or offloading from, a floating structure (70) as claimed in claim 1, in which liquefied gas is brought through insulated pipelines (73, 79, 76, 81) from or to a floating or on-shore storage facility (77) to or from the sealed and thermally insulated tank (71) of the floating structure.

16. A transfer system for low-temperature liquefied gas, the system comprising a floating structure (70) as claimed in claim 1, insulated pipelines (73, 79, 76, 81) designed to connect the sealed and thermally insulated tank (71) to a floating or on-shore storage facility (77) and a pump for driving a flow of cold liquid product through the insulated pipelines from or to the floating or on-shore storage facility to or from the tank of the carrier ship.
